(19) United States
(12) Patent Application Publication
(10) Pub. No.: US 2002/0044738 A1
(43) Pub. Date: Apr. 18, 2002

(54) Completely thin-film based composite dispersion compensating structure and its method of use

(76) Inventors: Mark Kenneth Jablonski, Tokyo (JP); Kazuro Kikuchi, Kanagawa (JP); Yuichi Takushima, Kanagawa (JP); Yuichi Tanaka, Tokyo (JP); Kenji Furuki, Saitama (JP)

Correspondence Address: VENABLE, BAETJER, HOWARD AND CIVILETTI, LLP, P.O. BOX 34385, WASHINGTON, DC, 20043-9998, US

(21) Appl. No.: 09/951,624

(22) Filed: Sep. 14, 2001

(30) Foreign Application Priority Data
Sep. 14, 2000 (JP) 279467/2000

(51) Int. Cl. G02B 6/26; G02B 6/28

(52) U.S. Cl. 385/27; 385/39

(57) ABSTRACT

This invention, a composite dispersion compensation structure made up of at least two dispersion compensation elements in an opposing arrangement, can provide low cost dispersion compensation over a wide bandwidth by utilizing multiple reflections.

### BACKGROUND OF THE INVENTION

1. Field of the Invention

This invention relates to a completely thin-film based composite dispersion compensating structure and it's method of use.

2. Description of Related Art

It is recognized that the demand for higher bit rates and longer propagation distances in fiber optic light wave communication systems is steadily increasing. In such systems, fiber dispersion will become an increasingly important problem. Various possible dispersion compensation approaches will be tried. Presently, second order dispersion has become a huge problem and with it various compensation approaches have been proposed, whose effects we will soon see.

However, with respect to light wave transmission, the dispersion tolerances have become very strict. Compensation of only second order dispersion is insufficient, rather third order dispersion must also be compensated for.

Below, FIGS. 10 and 11 will be used to explain future second order dispersion compensation methods.

In FIG. 11 the dispersion characteristics as a function of wavelength of single mode fiber (SMF), dispersion compensation fiber (DSF), and dispersion shifted fiber (DSF) are shown. The label 601 is associated with the SMF dispersion versus wavelength curve, the label 602 is associated with the dispersion compensation fiber dispersion versus wavelength curve, and label 603 is associated with the DSF dispersion versus wavelength curve. In FIG. 11, the y-axis is dispersion and the x-axis is wavelength.

In FIG. 11, it is clear that light input into SMF fiber between the wavelengths of 1.3 μm and 1.7 μm experience dispersion that increases with wavelength. Light input into dispersion compensating fiber will experience dispersion that decreases with wavelength between the wavelengths of 1.3 μm and 17 μm. Light input into DSF will experience dispersion that decreases with wavelength between the wavelengths of 1.3 μm and the neighborhood of 1.55 μm and dispersion that increases with wavelength between the wavelengths of 1.55 μm and 1.8 μm. A 2.5 Gbps (every second 2.5 giga-bits) bit-rate DSF based fiber communication system operating at a wavelength near 1.55 μm, the zero dispersion point, would not suffer the hindering effects of dispersion.

With first second order dispersion compensation in mind, FIG. 10(A) shows wavelength versus time characteristics and light intensity versus time characteristics of the effects of second order dispersion, FIG. 10(B) shows a light wave transmission system that uses SMF in combination with dispersion compensation fiber for second order dispersion compensation, and FIG. 10(C) shows a light wave transmission system that uses only SMF.

In FIG. 10, label 501 and 502 refer to the input signal characteristics before entering the fiber. Label 530 and 531 refer to the SMF only based propagation system. Label 502 and 512 refer to input pulse characteristics after passing through the SMF based system denoted by label 530. Label 520 refers to a dispersion compensating fiber based propagation system composed of dispersion compensating fiber denoted by label 521 and SMF denoted by label 522. Label 503 and 513 show the characteristics of the input pulse, denoted by label 501 and 511, after passing through the system denoted by label 520. Label 504 or 514 refer to the characteristics of the output pulses after the input pulses denoted by label 501 and 511 have passed through the fiber transmission system denoted by 520 and then the new device discussed in this patent, a dispersion compensation element designed for third order dispersion compensation only. In such a system, the characteristics of the output pulses of 504 and 514 would be almost identical to the original characteristics of the input pulses of 501 and 511. Again, graphs 501, 502, 503, and 504 all have a y-axis representing wavelength and an x-axis representing time. Graphs 511, 512, 513, and 514 all have a y-axis representing the light signal intensity and an x-axis representing time. Labels 524 and 534 refer to transmitters, and labels 525 and 535 refer to receivers.

In long distance high speed light wave communication systems using normal SMF, the amount of dispersion increases going from short wavelengths near 1.3 μm to long wavelengths near 1.7 μm, which means that within this region longer wavelengths experience more delay than shorter wavelengths. An output signal pulse train, composed of wavelengths within this bandwidth (1.3 to 1.7 mm), of the SMF system denoted by label 530, is depicted by the graphs labeled 502 and 512. This spreading out of the pulses ultimately interferes with the detection capability of the receiver, as pulses overlap with their neighbors.

One of the methods for solving the problem of dispersion has been to use dispersion compensation fiber in the manner shown in FIG. 10(B).

Typical dispersion compensation fiber has a dispersion profile where the dispersion decreases going from short wavelengths to long wavelengths, from 1.3 μm to 1.7 μm, in order to compensate for the dispersion profile of typical SMF where the dispersion increases going from short wavelengths to long wavelengths.

One can connect dispersion compensation fiber, labeled 521, to SMF, labeled 522, in the manner shown by label 520 in FIG. 10(B). In the system labeled 520, using SMF, labeled 522, having a delay which increases with increasing wavelength, in combination with dispersion shifted fiber having a delay which decreases with increasing wavelength, one can depict the output of the dispersion compensation fiber as shown in the graphs labeled 503 and 513, where it is clear that the much of the changes shown in the graphs labeled 502 and 512 has been suppressed.

However, dispersion compensation fiber will not return the propagating pulse back to the input pulse form shown by the graph labeled 501. Dispersion compensation fiber, as a second-order dispersion compensation technique, can only compensate a traveling pulse up to the form shown by the graph labeled 503. At this point, both the longer wavelengths and shorter wavelengths of the signal have a greater delay than the center wavelength of the signal. This delay profile results in a pulse with a characteristic ripple on the fall of the pulse, as shown in the graph labeled 513, and is called third-order dispersion.

This phenomenon of third-order dispersion becomes a serious problem with increasing bit-rates and distances, as the required accuracy for detection becomes greater. For example, in systems using bit rates of 10 Gbps (10 gigabits every second) and greater, this phenomenon is a serious worry, and for 40 Gbps and greater systems [over distances of only 80 km], the worry is even greater.

Therefore, for future high-speed optical communication systems, it will become difficult to use today's normal fiber systems. It may become necessary to change the fiber material being used, for example. System construction, from an economic viewpoint will become of increasing importance. Given the difficulties associated with only second-order dispersion compensated systems, it is clear that third-order dispersion compensation is necessary.

It is clear from FIG. 10 and FIG. 11, that DSF has very little second-order dispersion in the vicinity of 1.55 μm, but cannot compensate for third-order dispersion, the subject of this section.

The phenomenon of third-order dispersion in high-speed long distance light communication systems, and the necessity of compensating for it, is gradually becoming recognized as being important. There have been many attempts at compensating for third-order dispersion, but none of them have been successful enough to be realized.

One example of a third-order dispersion compensation device, that is proposed by the inventors, a dielectric thin-film device, can successfully compensate for pure third-order dispersion, and as such has the potential for greatly advancing light wave communication systems.

In high bit-rate optical fiber communications, for example 40 Gbps and 80 Gbps, both second and third-order dispersion compensation is necessary. For a many channel light wave system, sufficient broad bandwidth third-order dispersion compensation or narrow bandwidth (only the channel portions of the band) second-order dispersion is necessary.

In order to compensate the dispersion in each channel, the inventors propose a dispersion compensation element that is adjustable in wavelength. In addition they propose a dispersion compensation element that is adjustable in both wavelength bandwidth and amount of group delay (amount of dispersion compensation adjustable).

Using simply one dispersion compensation unit, it is extremely difficult to obtain a sufficiently wide bandwidth group delay characteristics, a sufficient amount of dispersion compensation, as well as complex group delay shapes.

The proposed dispersion compensation elements can be cascaded in series to produce excellent group delay versus wavelength characteristics or good dispersion compensation. These elements can be connected together, for example via a collimator type lens assembly, to produce much larger size dispersion characteristics. However, an important question is how small can the loss be made, as the total loss is proportional to the number of elements, since the loss is additive.

If the dispersion seen by the light signal changes, the amount of dispersion compensation provided by the dispersion compensation element has to change correspondingly. However, for bandwidths as wide as 30 nm and 40 nm, changing the amount of dispersion compensation is difficult.

When connecting these dispersion compensation elements in series, to make broad bandwidth dispersion characteristics, for example at 30 nm, it is critical to be able to connect these elements in a simple, low loss manner.

In consideration of the points discussed below, the purpose of the inventors is the realization of a device with sufficient dispersion compensation over a broad bandwidth. Specifically, being able to produce the required group delay versus wavelength characteristics necessary for the required amount of third-order dispersion compensation, using a small device, that is easy to use, has low loss, has high reliability, is suitable for production, and low-cost. In other words, using a thin-film unit as the base, being able to provide adjustable group delay bandwidth with adjustable group delay for the purposes of third-order dispersion compensation, or second and third-order dispersion compensation together.

### SUMMARY OF THE INVENTION

In order to obtain the goals presented previously in a light transmission system using fiber as the transmission medium, the inventors propose the combining of many dispersion compensation elements into composite dispersion compensation elements, where at least each composite dispersion compensation element is composed of at least a pair of dispersion compensation elements or units, that are placed in an opposing arrangement, where the input light surface is opposite to another surface. This construction is distinctive to this device.

Connecting dispersion compensation units in series using collimator and lens assemblies rapidly results in a high accumulation in loss. By making a composite dispersion compensation device, utilizing the principle of multiple reflections, only one collimator and lens assembly is necessary, reducing the total loss of the dispersion compensation structure significantly. Furthermore, by adjusting the optical path within the composite dispersion device, the group delay versus wavelength characteristics can be altered to produce greater dispersion compensation over a wider bandwidth.

With regards to the ideal example of a composite dispersion compensation element proposed by the inventors, each of the dispersion compensation units that make it up must possess at least two light reflection layers (or simply reflection layers) and one light transmission layer (or simply one transmission layer). The transmission layer is always sandwiched between two reflection layers. The reflection layer will also be referred to as mirror layers and the transmission layer will also be referred to as cavity layers. One of the mirrors must be of high reflectance, typically equal to or greater than 99.5% at the center wavelength (also referred to as λ₀) of the dispersion compensation unit. The mirrors will be of increasing reflectance values, with the lowest mirror reflectance value possessed by the mirror that the light first impinges on.

A composite dispersion element composed of dispersion compensation units made up of stacks of single layers can be realized cheaply.

A layer structure can be applied to different or separated substrates to make a multiple reflection composite dispersion compensation structure. The light can also be input into one end of the substrate, with the thin-film layers, making up the dispersion compensation part, being deposited on the opposing end of the substrate. The dispersion characteristics of this kind of composite dispersion element can be improved and miniaturized, with a lower manufacturing cost.

With respect to the composite dispersion compensation structure, the input and output light can appear on opposing dispersion compensation units. In a similar manner, the input and output can appear on the same dispersion compensation unit. The configuration is dependent upon the intended use, and having both options allows for a broadening of applications.

With respect to this invention, a composite dispersion compensation structure, the surface of one of the pair of dispersion compensation units, where the light is input upon, can be placed in an arrangement that it is not parallel to the opposing dispersion compensation unit or surface. In a similar manner, the surface of one of the pair of dispersion compensation units, where the light is incident upon, can be placed in an arrangement that is parallel to the opposing dispersion compensation unit or surface. The configuration of the composite dispersion compensation structure is adaptable, dependent upon the requirements or conditions.

With respect to this invention, a composite dispersion compensation device, as an example, each of the dispersion compensation units can consist of two cavities made up of thin-film layers, whose differing optical characteristics can be broken down into five sub-elements, with each sub-element possessing unique optical qualities, such as reflectance and optical thickness (or optical path length), which are determined by the thin-film layers that they are composed of. Of the three sub-elements that must be mirrors, two of these sub-elements must have differing reflectance values. The two remaining sub-elements are composed of transmission or spacer layers, also referred to as cavity layers. Each cavity layer is between two mirrors or reflection layers. The layers always appear in an alternating fashion, mirror, cavity, mirror, cavity, and mirror, with the first mirror or the lowest reflection mirror called the first layer, followed by the first cavity layer called the second layer, followed by the second mirror called the third layer, followed by the second cavity called the fourth layer, followed by the third mirror called the fifth layer. These layers all have a theoretical optical thickness of a quarter wavelength plus or minus 1% (hereafter referred to as λ₀/4, with λ₀ being the center wavelength of the filter as defined previously), where optical thickness or optical path length, is defined as the physical distance times the refractive index of the material. The refractive index of the thin-film layers of a two material system will either be a high relative value, referred to as H, or a low relative value, referred to as L. The following list of dispersion compensation units (denoted by A, D, E, and I), provide a purely quadratic group delay response over 2 nm, 2 nm, 3 nm, and 3 nm bandwidths respectively, and can be used as parts of a dispersion compensating pair. They all consist of five sub-elements, with light being input onto the layer farthest from the substrate. Dispersion compensation unit A provides a 2 nm bandwidth quadratic group delay. The first mirror in A consists of 3 sets or pairs of one thin-film layer H joined to one thin-film layer L. The first mirror or layer is followed by the first cavity or second layer consisting of 10 sets of one thin-film layer H joined to one thin-film layer H. The first cavity or second layer is followed by the second mirror or third layer consisting of one thin-film layer L followed by 7 sets of one thin-film layer H joined to one thin-film layer L. The second mirror or third layer is followed by the second cavity or fourth layer consisting of 38 sets of one thin-film layer H joined to one thin-film layer H. The second cavity or fourth layer is followed by the third mirror or fifth layer consisting of one thin-film layer L followed by 13 sets or pairs of one thin-film layer H joined to one thin-film layer L.

A=(HL)³(HH)¹⁰L(HL)⁷(HH)³⁸L(HL)¹³|Substrate

The cavity sub-elements in A, B=(HH)¹⁰ and C=(HH)³⁸, can be replaced by the thin-film layered structures denoted by Bₑ and Cₑ, defined below, without significantly affecting the dispersion compensation characteristics.

Be=(HH)³(LL)³(HH)³(LL)²(HH)¹

Cₑ=(HH)³(LL)³(HH)³(LL)³(HH)³(LL)³(HH)³(LL)³(HH)³(LL)³(HH)³(LL)³(HH)³(LL)³(HH)²

Dispersion compensation unit D provides a 2 nm quadratic group delay bandwidth.

D=(LH)⁵(LL)⁷H(LH)⁷(LL)⁵⁷H(LH)¹³

Dispersion compensation unit E provides a 3 nm quadratic group delay bandwidth.

E−(HL)²(HH)¹⁴L(HL)⁶(HH)²⁴L(HL)¹³

The cavity sub-elements in E, F=(HH)¹⁴ and G=(HH)²⁴, can be replaced by the thin-film layered structures denoted by Fₑ and Gₑ, defined below, without significantly affecting the dispersion compensation characteristics.

$$\begin{matrix}Fe = {( HH )}^{3} {( LL )}^{3} {( HH )}^{3} {( LL )}^{3} {( HH )}^{2} {( LL )}^{1} {( HH )}^{1} \\ Ge = {( HH )}^{3} {( LL )}^{3} {( HH )}^{3} {( LL )}^{3} {( HH )}^{3} {( LL )}^{3} {( HH )}^{3} {( LL )}^{3} {( HH )}^{2} {( LL )}^{1} {( HH )}^{1}\end{matrix}$$

Dispersion compensation unit H provides a 3 nm quadratic group delay bandwidth.

H=(LH)⁴(LL)⁹H(LH)⁶(LL)³⁵H(LH)¹³

With respect to this invention, a composite dispersion device, specifically the dispersion compensation units that make it up which in turn are made up of an accumulation of thin-film layers. These layers can have a taper, meaning that the layer thickness changes with distance, in the plane of the cross section parallel to the surface of the thin-film layers.

With respect to the composite dispersion device, specifically the dispersion compensation units that make it up which in turn are made up of an accumulation of thin-film layers. The cavity layers of each of the dispersion compensation units can have different tapers, meaning that the layer thickness changes with distance, in both amount and direction. The tapers are preferably in directions that are between 60 and 120 degrees apart with the optimum difference in directions being 90 degrees.

The thin-film layers of the dispersion compensation units can have tapers in the same direction.

FIGS. 2 through 5 will be referred to later to show that the group delay versus wavelength characteristics of this invention, a composite dispersion device, can be freely chosen.

With respect to the composite dispersion device, each of the dispersion compensation units, discussed before as having tapers, can be adjusted in position relative to the other dispersion compensation unit in position, effectively changing the positions of the light beam on one of the surfaces.

Depending upon the structure of this invention, a composite dispersion compensating device, one can make a device that is easy to adjust, cheap, and have even a greater dispersion compensation effect.

As this invention, a composite dispersion compensation device, can be made to compensate for mainly third order dispersion or mainly second order dispersion, its range of use is quite wide.

The purpose of the above explanation was to give a clear outline of the characteristics of the invention, a composite dispersion compensation device. However, it is also the purpose of the inventors to explain the practical realization or construction of this composite dispersion compensation device, which is done in the following explanation.

As this invention, the ideal example of a dispersion compensation method to be used to compensate for wavelength dispersion in a light fiber communications system to compensate is a composite device with at least a pair of surfaces in an opposing arrangement. The incoming light reflects off one surface, then the next, and so on, in an alternating manner, many times, with each reflection resulting in dispersion compensation. Other optical elements, such as a mirror or prism, can be inserted into the optical path connecting input and output light.

With respect to the method of dispersion compensation used by this invention, both dispersion compensation units can be parallel to each other or at an angle to each other. When the dispersion compensation units are at a suitable chosen angle to each other, the input and output light paths can be made to be close to each other. Using this concept freely enables an improve effect.

With respect to this invention, the composite dispersion compensation device, the thin-film layers of the dispersion compensation units can have a taper, for control of dispersion compensation. Each of the dispersion compensation units can be adjusted in position relative to the other dispersion compensation unit, effectively changing the positions on the surfaces where the light is incident.

With respect to this invention, each of the dispersion compensation units can have, in the wavelength range between 1460 and 1640 nm, one point where the slope of the group delay versus wavelength curve is zero.

In this invention, a composite dispersion compensation element, any or both of the dispersion compensation elements can be used to compensate for either third-order dispersion mainly, or second-order dispersion mainly.

This dispersion compensation method has many advantages over existing methods. For example, when compared to fiber bragg gratings, there is no group delay ripple and no stability problems (for example with respect to pressure and temperature), when compared to waveguide devices, there is no polarization dispersion problems, and when compared to other spatial optic compensators there is very little loss.

### BRIEF DESCRIPTION OF THE DRAWINGS

The foregoing and other objects, features and advantages of the present invention will be better understood from the following description taken in connection with accompanying drawings, in which:

FIG. 1 is an explanation of dispersion compensation provided by this invention.

FIG. 2 is a cross section of the thin-film layers used by this invention.

FIG. 3 is an oblique view of the thin-film layers used by this invention.

FIG. 4 shows some group delay versus wavelength curves characteristic of this invention.

FIG. 5 is a figure used to explain a method based on connecting many units for improving the group delay versus wavelength characteristics of this invention.

FIG. 6 is a figure showing some of the possible connections between dispersion compensation units.

FIG. 7 is a figure used to explain an example of a composite dispersion compensation structure.

FIG. 8 is a figure used to explain an example of a composite dispersion compensation structure.

FIG. 9 shows the group delay versus wavelength characteristics of the composite dispersion compensation structure 701.

FIG. 10 is an explanation of a method for compensating for both second and third-order dispersion.

FIG. 11 is a figure that shows the dispersion characteristics of standard types of available fibers.

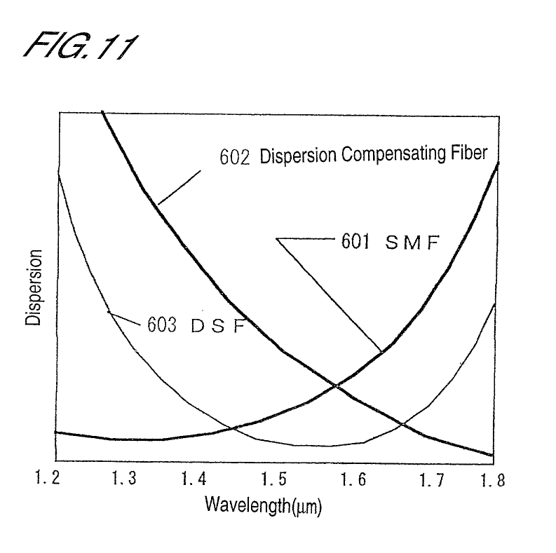

### DESCRIPTION OF PREFERRED EMBODIMENTS

The figures regarding the practical realization of the form of this invention will be referred to below. In order to understand this invention, a general outline of the components making up the device, the general shape, and arrangement of the sub-components will explained with respect to figures. Concerning the circumstances of the explanation of this invention, some figures will show magnified versions of the structures showed in other figures. Not all the realizable forms of this invention, described in this patent will have similar figures. In each figure structural parts that are the same will be labeled with the same number. Overlapping explanations may be abbreviated.

Concerning the discussion of the invention below, light dispersion compensation or simply dispersion compensation, light dispersion compensation element or simply dispersion compensation element, and light dispersion compensation method or simply dispersion compensation method are used.

In a fiber propagation or communication system, for example with a light signal propagating in the vicinity of 1.55 μm, second order and above dispersion (to be explained later) occurs due to the structure of the fiber. We propose a low loss dispersion compensation unit that can compensate for second order and above dispersion, in both a fixed and changeable manner. Two of these elements, when placed in an opposing arrangement, constitute a composite dispersion compensation element or construction.

This invention, in a low loss manner can compensate for second and third order dispersion and above in a highly effective manner.

With respect to the discovered composite dispersion compensation, it can compensate for many types of dispersion depending upon the arrangement of the two dispersion compensation units relative to each other. For example, it can compensate for only third-order dispersion, only second-order dispersion, both second and third-order dispersion, and greater than third-order dispersion.

There are various forms that this invention, a dispersion compensation element can take, for the purposes of sales or other uses.

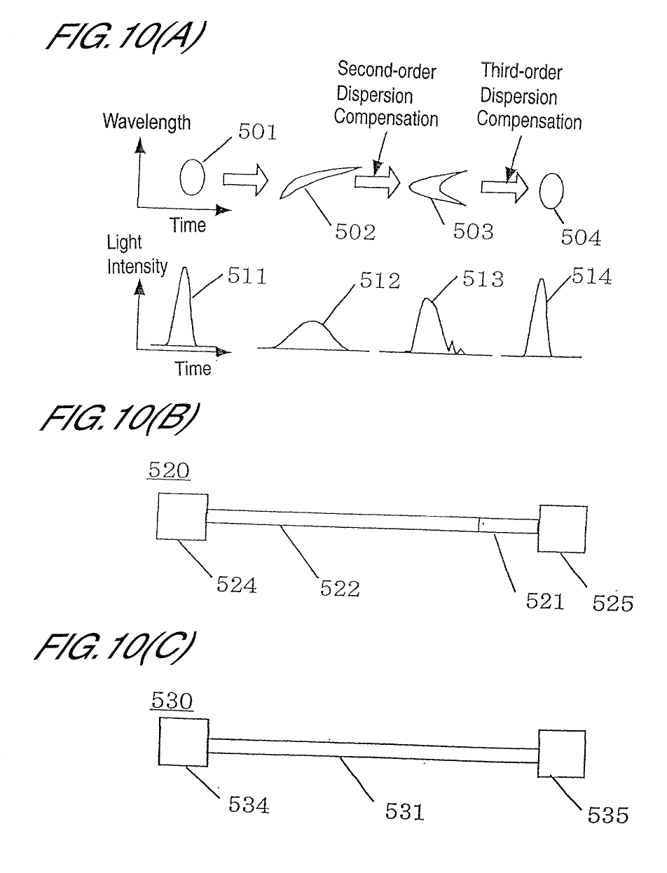

The meaning of second and third order dispersion is shown graphically in FIG. 10(A), in a graph of wavelength versus time, with first second and then third order dispersion compensated for. Second order dispersion causes the wavelength versus time curve to stretch and elongate. Third order dispersion causes the wavelength versus time curve to have a quadratic dependence.

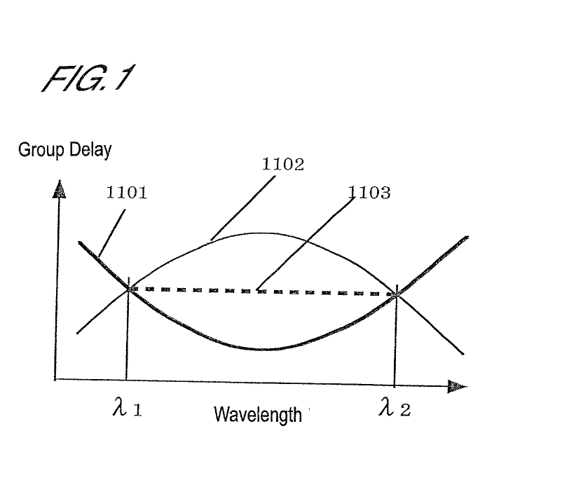

FIG. 1 is used to explain the concept of dispersion compensation in a fiber transmission system. The curve labeled 1101 is the remaining dispersion of the fiber, after the second order dispersion of the fiber has been compensated. This remaining dispersion is referred to as third-order dispersion. This remaining third-order dispersion can be compensated using a third-order dispersion compensation device with the group delay versus wavelength characteristics labeled 1102. The group delay versus wavelength characteristics of the combination of the third-order dispersion compensation device plus the fiber is described by the curve labeled 1103. In FIG. 1, compensation is shown as occurring between wavelength λ₁ and λ₂, resulting in the flat curve labeled 1103. In FIG. 1, the vertical-axis is the group delay and the horizontal-axis is wavelength.

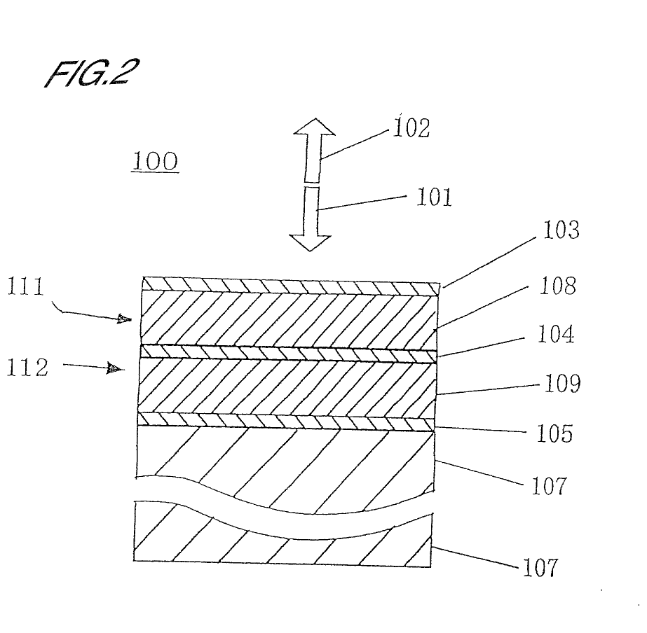

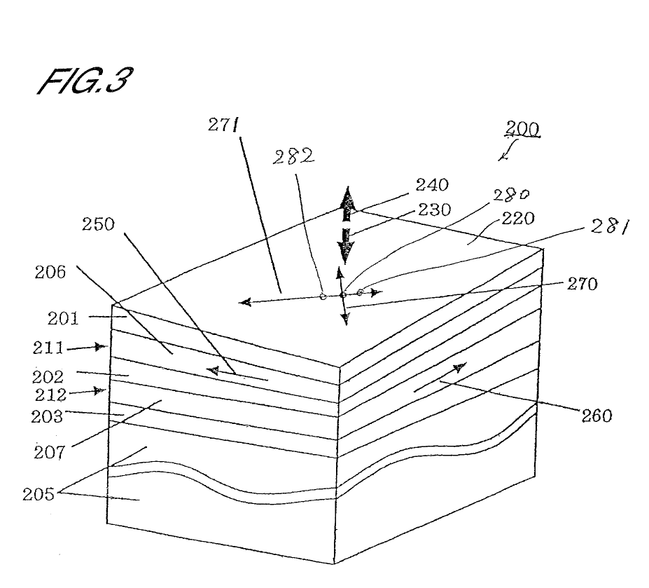

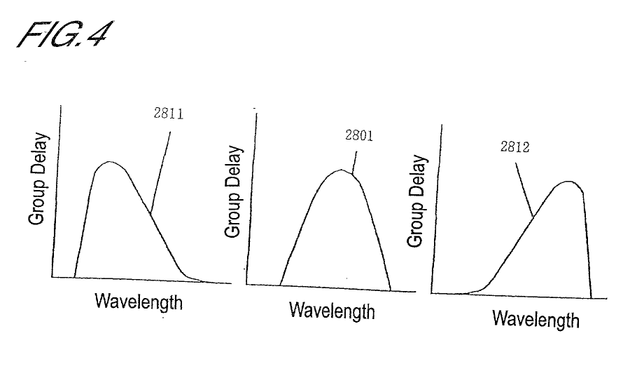

FIGS. 2 through 4 show the structure of the dispersion compensation elements (the dispersion compensation elements make up the composite dispersion compensation device in a manner where each dispersion compensation element has an opposing dispersion compensation element making up a set of opposing surfaces. As each dispersion compensation element can act alone as a dispersion compensator, it will be referred to as dispersion compensation element or dispersion compensation unit to distinguish it from the composite dispersion compensation device) that are the subject of this invention. FIG. 2, to be discussed later, shows the cross section of the thin-film layers making up a dispersion compensation element, FIG. 3 shows how the thin-film layer thickness values can vary with distance, and FIG. 4 shows the group delay versus wavelength characteristics of the thin-film layer structures.

An example of the structure of the dispersion compensation unit of this invention is shown in FIG. 2. In FIG. 2, the cross section of the thin-film layers is shown. Label 100 refers to the thin-film structure of the dispersion compensation unit. The arrow of label 101 refers to the direction of the input light. The arrow of label 102 refers to the direction of the output light. Labels 103 and 104 refer to the mirror layers (referred to as reflection layer or light reflection layer) where the reflection is below 100%. Label 105 refers to the mirror layer having the highest reflection value, between 98 and 100%. Labels 108 and 109 refer to the light transmission layers (or simply transmission layers) and layers 111 and 112 refer to the cavities. Label 107 refers to the substrate, for example BK-7 glass.

The relation between the reflectance values, R(103), R(104), and R(105), of each of the mirror layers, labeled 103, 104, and 105, in FIG. 2 is that R(103)<=R(104)<=R(105). If the above condition is changed so that R(103)<R(104)<R(105) then it becomes easier to produce these devices. The closer the reflectance of R(105) is to 100% the better the performance of the device. That is to say, the center wavelength of the input light sees reflection layers whose reflection values gradually increase with distance into the filter, finally ending in a reflection value as close to 100% as possible. It is desirable to have reflection layers with reflection values that lie within the following ranges, where 60%<=R(103)<=77%, 96%<=R(104)<=99.8%, 98%<=R(105). Various group delay versus wavelength characteristics can be realized when R(103), R(104), and R(105) are allowed to vary within the stated constraints. One can increase the performance of these dispersion elements by ensuring that the reflectance of R(105) is as close to 100%.

For ease of production of the dispersion compensation elements, the cavity layer optical path lengths are allowed to be different. Allowing the cavity lengths to be different gives more freedom in the design conditions associated with the allowable range of reflection values of the reflection layers. The thin-film structure is entirely composed of quarter wavelength layers, the basic structural unit of these devices, and so the optical thickness is an integer multiple of a quarter wavelength. The realization of a third-order dispersion compensator using such a structure simplifies production, and results in a product that has high reliability as well as low cost.

In reality, when considering the production of these thin-film structures, the basic unit of the thin-film dispersion compensation unit, a quarter wavelength, has an allowable tolerance region. For the purposes of this device, it is sufficient that the layer unit tolerances fall with λ/4+/−3.0%. However, if the layer unit accuracy becomes higher, for example λ/4+/−1.0%, then the production yield will improve. If the layer unit accuracy is further increased to λ/4+/−0.5% then the production yield increases still more, as for example, the deviations of the device center wavelength from the desired center wavelength decreases with increasing layer accuracy. Units produced within this tolerance will have a high reliability yield resulting in an overall production cost that is less.

Concerning the formation of the quarter wavelength layers that make up the structure of the dispersion compensation units. Each quarter wavelength layer, the basic unit of these devices, is formed on top of the next one, in a continuous process. The resultant filter is entirely composed of quarter wavelength layers, in other words a multiple of an integer number of quarter wavelengths. This means that the reflection layer and transmission layer are also in turn composed of quarter wavelength layers that were deposited in a continuous process.

The thin-film structure of FIG. 3 is the same as the thin-film structure labeled 100 in FIG. 2 except that the width of the thin film layers change with distance.

FIG. 3 shows an example of a thin-film dispersion compensation unit, labeled 200, that is the basic building block used in our discovery. The first, second, and third reflection layers are labeled 201, 202, and 203 respectively. The substrate is labeled 205, and the first and second transmission layers are labeled 206 and 207 respectively. The first and second cavities are labeled 211 and 212 respectively. Label 220 indicates the surface where the light is incident on and label 230 shows the direction of the incident light. Label 240 shows the direction of the output light. Label 250 shows the direction of the first taper or change of layer thickness. Label 260 shows the direction of the second taper or change of layer thickness. Labels 270 and 271 show two possible directions or paths that the light takes in a multi-reflection configuration.

The order of the layers from the substrate, labeled 205, for example BK-7 glass, is the third reflection layer 203, the second transmission layer 207, the second reflection layer 202, the first transmission layer 206, and the first reflection layer 201.

The thickness of the first transmission layer, 206, varies in the direction indicated by the arrow, 250, in FIG. 3. The thickness of the second transmission layer, 207, varies in the direction indicated by the arrow, 260, in FIG. 3. When the center wavelength of the first and second cavity are the same, the relation or condition mentioned before between R(103), R(104), and R(105) must be satisfied.

The reverse order of the thin-film layers is also valid. In other words, referring to FIG. 3, the light can be incident first upon a suitable substrate, followed by the first reflection layer, 201, followed by the first cavity layer, 206, followed by the second reflection layer, 202, followed by the second cavity layer 207, followed by the third reflection layer, 203. In this order, the condition that R(103)<=R(104)<=R(105) must still be maintained.

The group delay versus wavelength characteristics of the thin-film dispersion compensation element labeled 200 in FIG. 3, are shown in FIG. 4, when the light is incident upon surface 220 in the direction of label 230 and the output light is labeled 240, under two possible multiple reflection paths labeled 270 and 271.

The group delay versus wavelength characteristics when the incident beam of center wavelength λ₀ is incident on three different places, 280, 281, and 282 in FIG. 3, is shown in FIG. 4. The vertical axis is group delay and the horizontal axis is wavelength.

In FIG. 4, the group delay versus wavelength curve labeled 2801 results whenever light is incident upon any of the points along the path labeled 270 in FIG. 3. The group delay versus wavelength characteristics hardly change, but the center wavelength, λ₀, does change. The center wavelength is the point on the group delay versus wavelength curve where the slope is zero. When the light is incident upon any of the points along the path labeled 271, except for the intersection between 271 and 270, in FIG. 3, then either one of two possible group delay versus wavelength curves, labeled 2811 and 2812, can result. Along this path, the center wavelength changes very little, but the group delay characteristics change significantly. Simply, a filter possessing cavity layers that monotonically increase in opposite directions, as labeled 250 and 260 in FIG. 3, can have group delay versus wavelength characteristics as shown by the curves in FIG. 4.

Depending on the dispersion compensation application, the center wavelength, λ₀, of the graphs 2801, 2811, and 2812 in FIG. 4, can be adjusted suitably, as well as the particular group delay characteristics can be set. For example, though not shown here, between the graphs 2801 and 2812 there exist many possible group delay shapes.

In order to match the dispersion compensation element wavelength to the desired wavelength in the optical signal, the optical signal can be moved along the line labeled 270 in FIG. 3. In order to adjust the group delay versus wavelength characteristics of the filter to match the desired characteristics, the optical signal can be moved along the line labeled 271 in FIG. 3. The point of intersection where lines 270 and 271 cross is the optimal point where the input optical signal should enter the dispersion compensation element.

Looking at the group delay versus wavelength characteristics in FIG. 4, it is clear that the just the dispersion compensation element labeled 200 in FIG. 3 can be used for both pure third-order dispersion compensation, as evidenced by the graph labeled 2801, and second-order dispersion compensation, as evidenced by the graphs labeled 2811 and 2812.

It is clear from the above explanations regarding FIGS. 2 through 4 concerning a dispersion compensation element, that given the graphs of FIG. 1 and FIG. 4, that these elements are capable of third-order dispersion compensation. Furthermore, with respect to using these devices in a composite dispersion compensation device, the invention referred to in this patent, it is clear that dispersion compensation will occur.

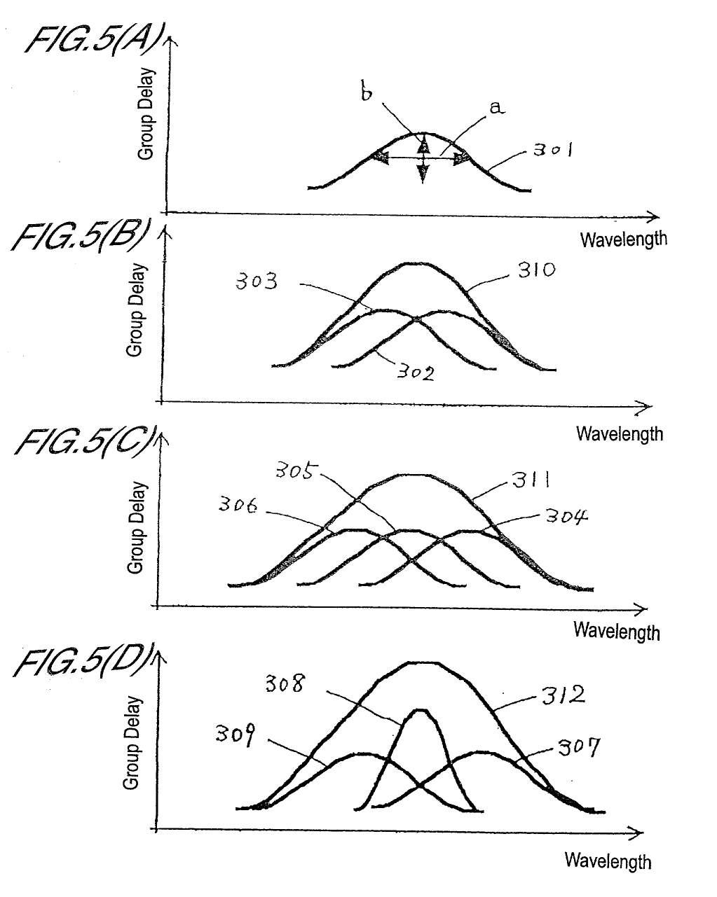

Individually, the thin-film based dispersion compensation elements discussed before have group delay versus wavelength characteristics that offer dispersion compensation over a bandwidth on the order of 3 nm with a group delay peak between 2 and 10 ps. While this bandwidth and group delay peak is sufficient for a single channel in a light wave communication system, it is not sufficient for multiple channels. Multiple channel systems can typically require bandwidths between 10 and 30 nm as well as much larger group delay peak values. Therefore, it is necessary to improve on the dispersion characteristics of the thin-film based compensation elements discussed so far in order to be able to compensate for the dispersion of many channels. FIGS. 5 through 10 are used in the explanation that follows concerning the improvement of the dispersion compensation element.

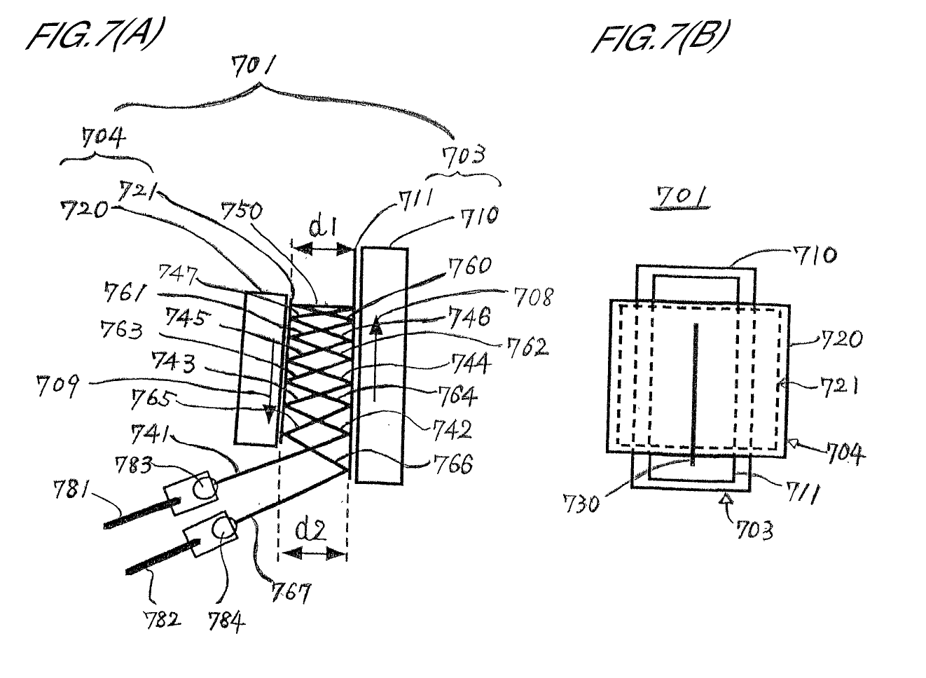

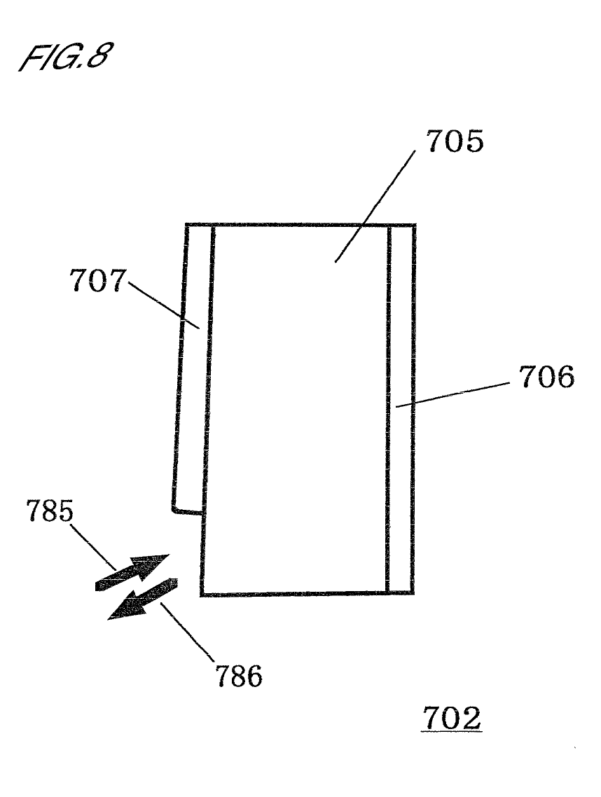

FIG. 5 shows the group delay versus wavelength characteristics and hence the dispersion compensation characteristics can be improved by cascading many dispersion compensation elements. FIG. 5(A) shows the group delay versus wavelength characteristics of only one dispersion compensation element. FIG. 5(B) shows the result of either cascading two dispersion compensation elements possessing similar group delay versus wavelength characteristics but at different center wavelengths or using two reflections along a line in a composite dispersion compensation structure made up of two dispersion compensation elements possessing similar dispersion characteristics but at different center wavelengths. In a similar manner the number of cascaded dispersion elements can be increased to three and four or equivalently the number of reflections in a composite structure can be increased to three and four. FIG. 5(C) shows the results of cascading three dispersion compensation elements possessing similar group delay versus wavelength characteristics but different center wavelengths. FIG. 5(D) shows the results of cascading three dispersion compensation elements, two possessing similar group delay versus wavelength characteristics and one possessing different group delay versus wavelength characteristics, all having different center wavelengths. In all the graphs in FIG. 5, the vertical axis is group delay and the horizontal axis is wavelength. The realization of a device capable of realizing the dispersion characteristics shown in the graphs of FIG. 5 is the discovery written about in this patent. For example, such a device, to be discussed later, is shown in FIGS. 7 and 8, a composite dispersion compensation structure. Such a device can be placed at suitable positions along the path of a light wave fiber communication system. For example, at a receiver, before or after an amplifier, for each channel after a demultiplexer (DMUX), after a transmitter, and after or before a regeneration point.

In FIG. 5, labels 301 thru 309 refer to the group delay versus wavelength characteristics of single dispersion compensation elements. Label 310 refers to the resultant group delay versus wavelength curve when two dispersion compensation elements with similar group delay versus wavelength characteristics but different center wavelengths are connected together. Label 311 refers to the resultant group delay versus wavelength curve when three dispersion compensation elements with similar group delay versus wavelength characteristics but different center wavelengths are connected together. Label 312 refers to the resultant group delay versus wavelength curve when three dispersion compensation elements, two of which have similar group delay versus wavelength characteristics but all having different center wavelengths are connected together. In FIG. 5(A), the label (a) refers to the dispersion compensation bandwidth (here in units of wavelength), and the label (b) refers the peak value of the group delay curve (here in units of time). In FIG. 5, the group delay versus wavelength curves labeled 302 thru 307 and 309 all have about the same group delay peak value and dispersion compensation bandwidth. However the curve labeled 308 has a dispersion compensation bandwidth that is smaller but a group delay peak value that is larger than the curves labeled 302 thru 307 and 309. The center wavelengths of the curves labeled 301 thru 309 are all different.

In FIG. 5(B), comparing the group delay versus wavelength characteristics of the resultant curve labeled 310 to the individual curves labeled 302 and 303, the group delay peak is 1.6 times as large and the dispersion compensation bandwidth is 1.8 times as wide. In FIG. 5(C), comparing the group delay versus wavelength characteristics of the resultant curve labeled 311 to the individual curves labeled 304, 305, and 306, the group delay peak is 2.3 times as large and the dispersion compensation bandwidth is 2.5 times as wide. In FIG. 5(D), comparing the group delay versus wavelength characteristics of the resultant curve labeled 312 to the individual curves labeled 307, and 309, the group delay peak is 3 times as large and the dispersion compensation bandwidth is 2.3 times as wide.

The group delay versus wavelength characteristics of the thin-film dispersion compensation elements explained in FIGS. 2 through 4 can be described by two parameters, the group delay peak value and the dispersion compensation bandwidth. By changing the design conditions of the reflection layers and the transmission layers these group delay versus wavelength parameters can be changed. This is illustrated in FIG. 5(D), where the group delay versus wavelength characteristics of the curve labeled 307 are different from the group delay versus wavelength characteristics of the curve labeled 308. Curve 307 had a lower group delay peak value but wider dispersion compensation bandwidth than curve 308. Such curves can be combined to produce all kinds of group delay versus wavelength characteristics.

These kinds of thin-film dispersion compensation elements can be realized, for example using the thin-film designs, A thru H, discussed in a previous section (include section name). Actual dispersion compensation elements have been realized using these designs, for example having center wavelengths at 1.55 mm, group delay peak values on the order of 3 ps, and dispersion compensation bandwidths between 1.3 and 2.0 nm.

The thin-film designs, A thru H, possess two transmission layers or cavities sandwiched between reflection layers. However, this is not the limit of the invention discussed in this patent. Structures with one, three, and four cavities are possible and have been realized.

By combining group delay versus wavelength characteristics, like those shown in FIG. 4 and FIG. 5(D), in the appropriate manner, not only can third-order dispersion be compensated for, but also residual second-order fiber dispersion.

One way to achieve effective dispersion compensation, dispersion compensation that is suitable for many situations, is to be able to adjust the group delay versus wavelength characteristics of the dispersion compensation element.

FIGS. 2 and 3 illustrate a form of thin-film adjustable dispersion compensation element, as the thickness of the two transmission layers vary with distance in opposite directions. By changing the position where the input light is incident on the surface of the element labeled 200, the group delay versus wavelength characteristics can be changed as well as the center wavelength. The method chosen to move the light across the surface of the dispersion compensation element is dependent upon the dispersion compensation situation. For example, a low cost solution would be to use a screw type of arrangement where the input beam could be moved by hand. However, if better adjustment accuracy was required, an electromagnetic step or continuous motor, or a voltage controlled PZT motor could be used. This method of adjustment can be combined with a prism, dual fiber ferule assembly, or optical waveguide type of element to produce an accurate, easy to use method of adjusting the position of the input beam on the surface of the dispersion compensation element.

With regards to the thin-film layers used to build this invention, a dispersion compensation element, it is necessary to define some terms and conventions. The thin-film structures are defined using quarter wavelength layers of SiO₂ and Ta₂O₅, labeled L and H respectively. These layers are deposited using an IAD (ion assisted deposition) process. When an H layer is deposited over an L layer, the resultant structure is considered one set, labeled LH. Thus 5 sets of LH, labeled (LH)⁵, would consist of ten layers in the order of LHLHLHLHLH.

In the same manner, when an L layer is deposited over another L layer, the resultant structure is considered one set, labeled LL. Thus 3 sets of LL, labeled (LL)³, would consist of six layers in the order LLLLLL. This same convention applies to the term HH.

In the explanation of this invention, the label H was connected with one example of a dielectric material, Ta₂O₅. However, other dielectric materials, such as TiO₂ and Nb₂O₅ as well as Si and Ge based materials are allowable. Similarly, the label L was connected with one example of a dielectric material, SiO₂, as it is both cheap and has a high reliability. However, other dielectric materials can be used, as long as their dielectric constant is less than the dielectric constant of the material that is associated with the symbol H.

Similarly, the process used to construct the thin-film structure or deposit the thin-film layers, L and H, was an IAD process. However, the construction of this invention is not limited to the use of this process. Other processes, such as sputtering and ion plating, can be used to produce effective dispersion compensation elements.

The dispersion compensation element, labeled 200 in FIG. 3, is in the form of a wafer. A desired section of the wafer can be cut out, including all the layers and substrate, in the vertical direction from input surface, 220 thru substrate 205. This sub-section or small chip can then be placed in combination with a collimator lens in a cylindrical case or tube to make a compact, dispersion compensation element.

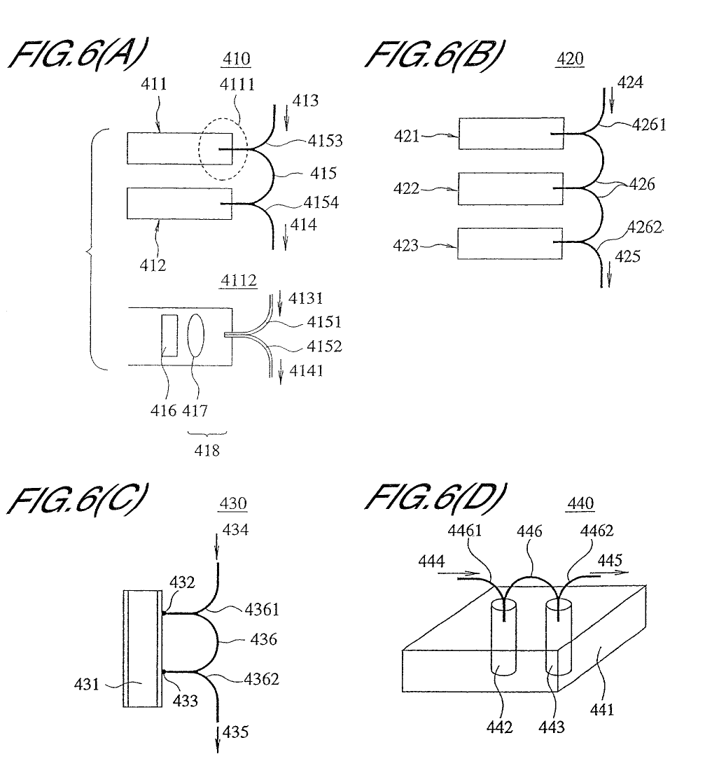

FIG. 6 shows the packaging structure and series connection of such structures necessary to achieve dispersion compensation devices possessing the group delay versus wavelength characteristics shown in FIG. 5. FIG. 6(A) shows two dispersion compensation elements directly connected in series where the light signal travels through both of them. FIG. 6(B) shows three dispersion compensation elements directly connected in series. FIG. 6(C) shows two separate positions on one thin-film structure, possessing transmission layers with tapers, being connected in series to form a net dispersion compensating structure. FIG. 6(D) shows the structure of FIG. 6(A) packaged in one case.

In FIG. 6, labels 410, 420, 430, and 440 refer to dispersion compensation structures based on the direct connection of dispersion compensation elements. Labels 411, 412, 421-423, 431, 442, and 443 refer to individual dispersion compensation elements. Label 416 is the thin-film portion of a dispersion compensation element. Labels 415, 4151-4154, 426, 4261, 4262, 436, 4361, 4362, 446, 4461, 4462 refer to fiber. Labels 413, 4131, 414, 4141, 424, 425, 434, 435, 444, 445 are arrows that show the direction the light signal is traveling. Label 418 refers to a DFFA (dual fiber ferule assembly) made up of a lens, labeled 417, and fiber, labeled by 4151 and 4152. Label 441 is a case. Label 431 refers to a thin-film wafer made up of thin-film layers deposited on a substrate where the width of the transmission layers change with distance. Labels 432 and 433 refer to two points on the surface of 431 where there is the desired dispersion compensation. Labels 415, 4152, 426, 436, and 446 refer to connecting fiber, inside the package. Labels 4151, 4153, 4154, 4261, 4262, 4361, 4362, 4461, and 4462 refer to input and output fiber external to the package.

In FIG. 6(A) the path of the light signal is as follows. The light enters the dispersion compensation structure in the direction shown by label 413, into the fiber labeled 4153. From 4153, the light enters the first dispersion compensation element labeled 411, where the light undergoes dispersion compensation. Next the light exits 411, and travels through fiber 415, entering the second dispersion compensation element labeled 412. After undergoing dispersion compensation, the light exits 412, entering fiber 4154 in the direction indicated by label 414.

Label 4112 refers to a blow up of the area bounded by the dotted line labeled 4111, showing the internal details of this area. This area is made up of two pieces of fiber, labeled 4151 and 4152, and a lens labeled 417, which make up the DFFA. Light enters fiber 4151 in the direction indicated by the label 4131, passing through the lens 417, and entering the thin-film chip labeled by 416.

The thin-film chip labeled 416 possesses the group delay versus wavelength characteristics shown in FIG. 5(A). Light that enters 416, first going through fiber 4151 and passing through lens 417, experiences third-order dispersion compensation. The light that exits 416, passes through lens 417 again, then goes through fiber 4152 in the direction labeled 4141 to enter the dispersion compensation element labeled 412. Fiber 4152 and fiber 415 are essentially the same. Fiber 4151 and fiber 4153 are also essentially the same. The dispersion compensated light signal, after passing through 412, goes through the output fiber 4154 in the direction labeled 414.

Light passing through the structure labeled 510 in FIG. 6(A) will experience dispersion compensation according to the group delay versus wavelength characteristics shown in FIG. 5 (B).

The light passing through fiber 4151 in the direction of 4131, entering the DFFA 418, reflecting off the thin-film dispersion compensating chip, 416, entering fiber 4152 in the direction of 4141 will experience from 0.3 to 0.5 dB loss, referred to as the coupling loss. This loss is quite small, for example in comparison to the loss of a fiber bragg grating. However, in order to achieve dispersion compensation over wider bandwidths, like 15 and 30 nm, the method described in FIG. 5 was introduced. In such a method, where the individual dispersion compensation elements are cascaded, the coupling loss can rapidly increase to where it becomes a serious problem. For example, just connecting 10 dispersion compensation units would result in coupling loss between 3 to 5 dB.

With the goal of making a dispersion compensation device or developing a dispersion compensation method that is valid for wider bandwidths, but without suffering a large coupling loss, FIGS. 7 through 9 are presented along with their explanation in the following discourse.

Before going into this discussion, a more detailed explanation concerning dispersion compensation is presented for a deeper understanding.

In FIG. 6(B), the light signal proceeds through device 420 in the following manner. Light enters fiber 4261 in the direction of 424, entering the dispersion compensation element 421. Dispersion compensated light outputs 421 to enter fiber 426. From this point on, the light experiences further dispersion compensation as it travels through dispersion compensation elements 422 and 423. The dispersion compensation experienced by the light that is output of device 420, traveling through fiber 4262 in the direction of 425, is according to the curve shown in FIG. 5(C).

The structure labeled 430 in FIG. 6(C), achieves the same dispersion compensation characteristics as the device shown in FIG. 6(A). In the structure shown in FIG. 6(C), fiber 436 is used to connect two points on the same wafer, labeled 432 and 433, whose dispersion characteristics are the same as the dispersion characteristics of the dispersion compensation elements 411 and 412.

Can compensate for dispersion in the manner depicted in FIG. 6.

The structure depicted in FIG. 6(D) can compensate for dispersion in the same manner as the structure of FIG. 6(A). Two DFFAs, 442 and 443 can be connected via fiber, 446, and locked in case 441. Light is input into fiber 4461 and output fiber 4462, the output of structure 440, after passing through 442 and 443. Not shown in this figure is that this structure, 440, is above a thin-film wafer of the form shown in FIG. 3. The structure, 440, could be moved via some electronic circuit, adjusting the positions of 442 and 443 over the wafer surface, and thereby changing the group delay versus wavelength curve.

In order to increase the dispersion compensation bandwidth and group delay peak, one can connect dispersion compensation elements in series to produce resultant group delay versus wavelength characteristics like the ones shown in FIG. 5.

However, using the method shown in FIG. 6, which involves connecting many collimator based dispersion compensating elements together, results in a large amount of loss. The inventors propose a dispersion compensation method or device to reduce this loss, as shown in FIGS. 7 and 8.

FIG. 7 is used to explain the details of the composite dispersion compensation structure. FIG. 7(A) shows a side view and FIG. 7(B) shows a view from the top. The dotted lines in FIG. 7(B) refer to the parts that cannot be seen from the top, but are explained about anyway.

In FIG. 7, label 701 refers to the composite dispersion compensation structure proposed by the inventors. Labels 703 and 704 are dispersion compensation elements, to be explained below, that can be connected in series as discussed previously. Labels 710 and 720 refer to substrates. Labels 711 and 721 refer to thin-film structures that are deposited above the substrates and that possess the group delay versus wavelength characteristics that are necessary for dispersion compensation. Label 730 outlines the path that the light single takes, to be discussed later, which is described by the labels 741 to 747, 750, and 760 to 767. Labels 781 and 782 refer to fiber. Labels 783 and 784 are lenses. Labels 708 and 709 describe the direction along which the thickness of the transmission layers change. D1 and d2 are the separation distances of 703 and 704 at the edges.

Label 701 shows the details of the composite dispersion compensation device, made up of two opposing dispersion compensation elements, 703 and 704.

The path of the light signal going through 701 in FIG. 7(A) is described as follows. The light signal enters through fiber 781, passes through lens 783, follows the light path 741 before reflecting off dispersion compensation element 703 and experiencing the dispersion compensation provided by the thin-film layers 711. The light then follows path 742 and reflects off dispersion compensating element 704, where it experiences dispersion compensation provided by the thin-film layers 721. In a similar manner, the light continues to reflect off surfaces 711 and 721, in an alternating fashion, following the path 743 thru 747, then returning back by following path 750, 760 thru 766, 767, entering lens 784, and finally entering fiber 782, the output of the composite dispersion compensation structure 701.

It is evident that at each reflection point on the dispersion compensation unit surfaces, 703 and 704, there is dispersion compensation in the same manner as if separate dispersion compensation units had been connected in series, as in FIG. 6.

The dispersion compensation elements, 703 and 704 are separated by dl at the top of FIG. 7(A) and separated by d2 at the bottom of FIG. 7(A) in the composite dispersion compensation structure, 701. The distance dl is shorter than the distance d2, such that when the input light, incident along path 741, reaches path 750, the reflection direction changes, and the light signal returns by way of path 760 thru 766, exiting the device via path 767. As an example of typical parameter values associated with the composite dispersion compensation structure 701 would be an input angle (the angle between the input light and the normal to surface 711) of 5 degrees, a distance d1 of 10 mm, and an input beam width along path 741 of 1 mm.

The dispersion compensation elements 703 and 704, consists of thin-film structures 711 and 721 deposited on substrates 710 and 720. The thickness of the layers of the layers, running from the bottom of the figure to the top of the figure can vary in the manner shown in FIG. 3. That is to say, the layer thickness is a function of position.

As one example, the transmission layers of the thin-film structures 711 and 721 could change in the directions indicated by the arrows 708 and 709 in a manner following the explanation of FIG. 3. In this way, the group delay versus wavelength characteristics of every point would have different peak group delay values and different dispersion compensation bandwidths.

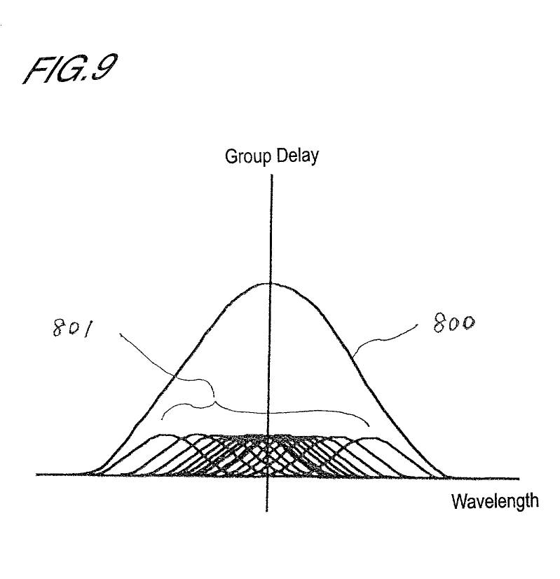

The resultant group delay characteristics of the composite dispersion compensation device 701, made up dispersion compensation elements 703 and 704, with input signal path 741, and output signal path 767 can be explained using an explanation to that given previously for FIG. 5. However, as there are many more reflections, one could imagine a resultant group delay versus wavelength characteristic curve as shown in FIG. 9, along with all the individual group delay versus wavelength characteristics that sum to it.

With a device like 701, where the signal light from the transmission fiber is input and output only once, the main contribution to loss is due the total reflection loss and not the coupling loss as discussed previously.

In general the coupling loss is much greater than the reflection loss. At each point along a dispersion compensation elements surface, there is a maximum reflection loss at the wavelength where the group delay is at a peak value. Typically, this is on the order of 1 dB. For wavelengths outside the compensation bandwidth the reflection is so small that it can be ignored.

The loss associated with this invention, a composite dispersion compensation device like the one in 701, is the sum of the losses of each reflection point along the signal light path, plus the one time coupling loss. This total loss is much less than the loss associated with directly connecting dispersion compensation elements in series, that is due to coupling loss summing over every element, as depicted in FIG. 6.

In FIG. 8 is shown another version of the composite dispersion compensation structure that is labeled 702. In this case, thin-film layers are deposited on both sides of the substrate 705. The thin-film layer structures on both sides are labeled 706 and 707 respectively, and are both able to provide dispersion compensation. The input light enters this device in the direction labeled 785, and exits this device in the direction labeled 786. The substrate thickness of the upper side is less than the bottom side in the same manner as thickness differences, d1 and d2, discussed in FIG. 7 (A).

The thin-film structures, 706 and 707 in FIG. 8 possess tapers similar to the tapers possessed by the thin-film structures of the dispersion compensation elements of FIG. 7(A).

In the composite dispersion structure 702 of FIG. 8, light enters in the direction of arrow 785 and follows a path of multiple reflections within substrate 705 in a similar manner to the device in FIG. 7(A). At each reflection there is dispersion compensation provided by the thin-film dispersion compensation elements 706 and 707. Finally, the light exits 702 in the direction of the arrow 786.

The thin-film structure of the dispersion compensation elements 706 and 707 can be described in a similar manner to the thin-film structures 711 and 721 in FIG. 7, which was done using FIGS. 2 through 4.

In FIG. 7(A) the thin-film structures, 711 and 721, deposited on substrates 710 and 720, must have at least two reflection layers and one transmission layer. The reflection layer farthest from the input light, or last reflection layer, has the highest reflection value. The reflection layer nearest to the input light, or first reflection layer, has the least reflection value. The reflection values going from the first reflection layer to the last reflection layer are in between the highest and lowest reflection values, but in increasing value with increasing distance from the first reflection layer. Each transmission layer must be sandwiched between two reflection layers.

For the purposes of dispersion compensation, the thin-film structures of FIG. 7(A) must possess any of the following arrangements of reflection layers and transmission layers. If there are two reflection layers then there must be one transmission layer or cavity. If there are three reflection layers then there must be two transmission layers or cavities. If there are four reflection layers then there must be three transmission layers or cavities. If there are five reflection layers then there must be four transmission layers or cavities.

There must be at least two reflection layers and one transmission layer in the thin-film structures 706 and 707 used in FIG. 8, and at least one reflection layer with a reflectance value greater than or equal to 99.5% as is the same for the thin-film structures in FIG. 7(A). The direction of increasing reflection values in 706 and 707 is opposite to the direction of increasing reflection values in 711 and 721. The reflection layers having the largest values in 706 and 707 are located farthest from the substrate 705.

The separation distances, d1 and d2, between the dispersion compensation elements 703 and 704 in FIG. 7 when chosen to be suitably different result in the input and output signals of FIG. 7(A) to appear on the same side. For the case of FIG. 7(A) d1<d2.

If the separation distances, d1 and d2, between the dispersion compensation elements 703 and 704 in FIG. 7 were chosen to be the same then the input and output signals of FIG. 7(A) would appear on opposite sides.

FIG. 9 is used to explain the resultant group delay versus wavelength characteristics of the composite dispersion structure displayed in FIG. 7(A). In FIG. 9, label 801 shows the group delay versus wavelength characteristics of each of the reflections that occurs when the light signal reflects off the surfaces of the dispersion compensation elements 703 and 704. As the arrows 708 and 709, depicting the change in thin-film layer thickness of 711 and 712, are in opposite directions, the resultant group delay versus wavelength curves are all symmetric. Label 800 refers to the resultant group delay versus wavelength curve when the group delay versus wavelength curves that result from single reflections are all combined.

The response of the composite group delay structure 701, depicted by the resultant group delay versus wavelength curve in FIG. 8, has a wider compensation bandwidth and larger group delay peak value than any of the group delay versus wavelength curves resulting from single reflections in 801. The loss of 701 is much less than if the same resultant group delay versus wavelength curve had been made using a connection of lens based units like the ones depicted in FIG. 6.

The composite dispersion compensation structure can not only be made up of one pair of dispersion compensation elements as discussed previously, but can be made up of many pairs of dispersion compensation elements.

With respect to the composite dispersion compensation structures shown in FIGS. 7 and 8, there are no extra internal components that are necessary. The only extra necessary components are external to the structures, like fiber and a coupling lens, PZT motor in the case of FIG. 7, and a prism or mirror for reflecting the light back towards the input side when the dispersion compensation elements are parallel.

One can achieve wide bandwidth dispersion compensation, for example 15 and 30 nm, by cascading multiple types of composite dispersion compensation elements, like the ones in FIGS. 7 and 8, with each other or with other types of dispersion compensation devices, like fiber bragg gratings.

Thus, using the appropriate optical path in the composite dispersion structure of FIG. 7, a low loss and wide bandwidth dispersion compensation is possible.

The subject of this invention, a composite dispersion compensation structure, by effectively using its component parts, i.e. two dispersion compensation elements, can compensate the dispersion over wide bandwidths of 15 nm and 30 nm. Furthermore, narrower bandwidths, for example between 5 to 10 nm, 3 nm and even 1 nm can be compensated for in light wave communication systems.

This kind of invention, a composite dispersion compensation structure, was used successfully in a 160 Gbit/sec fiber transmission system consisting of over 60 km of DSF. In this experiment, 1.6 ps pulses were pre-compensated by a cascade of two dispersion compensation elements, so that after traveling through 60 km of DSF, there was no distortion due to dispersion.

In this patent was described a composite dispersion compensation structure made up of dispersion compensation elements and the methods associated with using this structure and its elements for dispersion compensation. The main characteristic of the composite dispersion compensation structure was that many dispersion elements could be combined together, the minimum unit being a pair of opposing structures. A light signal would reflect off the two surfaces many times, with each time resulting in a little more dispersion compensation. The loss occurring between the input and output signal is overwhelmingly due to the individual reflection losses, which are far greater than the coupling loss. Such a device can provide both second and third order dispersion compensation over a wide bandwidth with low loss.

This invention, a composite dispersion compensation structure, is a very effective third-order and above dispersion compensation device as well as an effective second-order dispersion if the group delay versus wavelength curve is adjusted appropriately.

The composite dispersion compensation structure should have many uses in existing and future light wave communication systems, and in such a manner have a big effect on society and the economy.

What is claimed is:

1. A composite dispersion compensating structure comprising an arrangement of any number of pairs of dispersion compensating elements (or dispersion compensating units) that are thin-film based in an opposing arrangement, where the optical signal is input onto one of the elements can compensate for dispersion in an optical fiber communication system.

2. The composite dispersion compensating structure according to claim 1, wherein said dispersion compensation unit has at least two light reflection layers (or mirror layers) and one light transmission layer (transmission layer or cavity layer), said transmission layer being sandwiched between two reflection layers, one of said mirrors must have a high reflectance, typically equal to or greater than 99.5% at the center wavelength (also referred to as λ₀) of the dispersion compensation unit, and said mirrors being of increasing reflectance values, with the lowest mirror reflectance value possessed by the mirror that the optical signal first impinges on.

3. The composite dispersion compensating structure according to claim 1, wherein said dispersion compensation unit has many different possible structures of mirror and cavity layers that can be deposited upon a substrate.

4. The composite dispersion compensating structure according to claim 1, wherein two of said dispersion compensation units are joined by a common substrate to form a composite structure or a dispersion compensating element pair, the input light then first going through the common substrate before reaching the first mirror of one of the dispersion compensation units.

5. The composite dispersion compensating structure according to claim 3, wherein two of said dispersion compensation units share said substrate as a common substrate, and the mirrors closest to the substrate have the lowest reflectance values when compared to the other mirror values in their respective dispersion compensation units, the reflectance values of the mirrors in each dispersion compensation unit increasing with distance from the substrate.

6. The composite dispersion compensating structure according to claim 1, wherein one arrangement of the dispersion compensating units is so that the dispersion compensation unit where the first reflection of the input optical signal occurs is different than the dispersion compensation unit where the last reflection occurs, after said last reflection the optical signal being referred to as the output optical signal.

7. The composite dispersion compensating structure according to claim 1, wherein one arrangement of the dispersion compensating units is so that the dispersion compensation unit where the first reflection of the input optical signal occurs is the same as the dispersion compensation unit where the last reflection occurs, after said last reflection the optical signal being referred to as the output optical signal.

8. The composite dispersion compensating structure according to claim 1, wherein the opposing dispersion compensation units are in an arrangement where said dispersion compensation units are not parallel to each other.

9. The composite dispersion compensating structure according to claim 1, wherein the opposing dispersion compensation units are in an arrangement where said dispersion compensation units are parallel to each other.

10. The composite dispersion compensating structure according to claim 2, wherein each of the dispersion compensation units consists of two cavities made up of thin-film layers, whose differing optical characteristics are broken down into five sub-elements, with each sub-element possessing unique optical qualities, reflectance and optical thickness (or optical path length), which are determined by the thin-film layers that said sub-elements are composed of;
wherein three said sub-elements that are mirrors, two of these sub-elements have differing reflectance values, the two remaining sub-elements are composed of transmission or spacer layers, also referred to as cavity layers, each said cavity layer is between two mirrors or reflection layers, said mirror layers and cavity layers always appear in an alternating fashion, mirror, cavity, mirror, cavity, and mirror, with the first mirror or the lowest reflection mirror called the first layer, followed by the first cavity layer called the second layer, followed by the second mirror called the third layer, followed by the second cavity called the fourth layer, followed by the third mirror called the fifth layer, said thin-film layers all have a theoretical optical thickness of a quarter wavelength plus or minus 1% (hereafter referred to as λ₀/4, with λ₀ being the center wavelength of the filter as defined previously), where optical thickness or optical path length is defined as the physical distance times the refractive index of the material, the refractive index of the thin-film layers of a two material system either being a high relative value, referred to as H, or a low relative value, referred to as L, and the following list of dispersion compensation units (denoted by A, D, E, and I) and cavity sub-elements (denoted by Bₑ, Cₑ, Fₑ, Gₑ) are used as parts of a dispersion compensating pair, said dispersion compensation units all consisting of five said sub-elements, with the optical signal being input onto said mirror layer farthest from the substrate, the first mirror in said A consisting of 3 sets or pairs of one thin-film layer H joined to one thin-film layer L, the first mirror or layer being followed by the first cavity or second layer consisting of 10 sets of one thin-film layer H joined to one thin-film layer H, the first cavity or second layer being followed by the second mirror or third layer consisting of one thin-film layer L followed by 7 sets of one thin-film layer H joined to one thin-film layer L, the second mirror or third layer is followed by the second cavity or fourth layer consisting of 38 sets of one thin-film layer H joined to one thin-film layer H, the second cavity or fourth layer being followed by the third mirror or fifth layer consisting of one thin-film layer L followed by 13 sets or pairs of one thin-film layer H joined to one thin-film layer L;
$$\begin{matrix}A = {( HL )}^{3} {( HH )}^{10} {L ( HL )}^{7} {( HH )}^{38} {L ( HL )}^{13} \vert Substrate \\ {B}_{e} = {( HH )}^{3} {( LL )}^{3} {( HH )}^{3} {( LL )}^{2} {( HH )}^{1} \\ {C}_{e} = {( HH )}^{3} {( LL )}^{3} {( HH )}^{3} {( LL )}^{3} {( HH )}^{3} {( LL )}^{3} {( HH )}^{3} {( LL )}^{3} {( HH )}^{3} {( LL )}^{3} {( HH )}^{3} \\ {( LL )}^{3} {( HH )}^{3} {( LL )}^{3} {( HH )}^{2} \\ D = {( LH )}^{5} {( LL )}^{7} {H ( LH )}^{7} {( LL )}^{57} {H ( LH )}^{13} \\ E = {( HL )}^{2} {( HH )}^{14} {L ( HL )}^{6} {( HH )}^{24} {L ( HL )}^{13} \\ Fe = {( HH )}^{3} {( LL )}^{3} {( HH )}^{3} {( LL )}^{3} {( HH )}^{2} {( LL )}^{1} {( HH )}^{1} \\ Ge = {( HH )}^{3} {( LL )}^{3} {( HH )}^{3} {( LL )}^{3} {( HH )}^{3} {( LL )}^{3} {( HH )}^{3} {( LL )}^{3} {( HH )}^{2} {( LL )}^{1} {( HH )}^{1} \\ H = {( LH )}^{4} {( LL )}^{9} {H ( LH )}^{6} {( LL )}^{35} {H ( LH )}^{13}\end{matrix}$$
and wherein the cavity sub-elements in A, B=(HH)¹⁰ and C=(HH)³⁸, can be replaced by the thin-film layered structures denoted by Bₑ and Cₑ, defined above, without significantly affecting the dispersion compensation characteristics, the cavity sub-elements in E, F=(HH)¹⁴ and G=(HH)²⁴, can be replaced by the thin-film layered structures denoted by Fₑ and Gₑ, defined above, without significantly affecting the dispersion compensation characteristics.

11. The composite dispersion compensating structure according to claim 2, wherein the thickness of said cavity layer is constant.

12. The composite dispersion compensating structure according to claim 2, wherein the thickness of said cavity layer is changing.

13. The composite dispersion compensating structure according to claim 2, wherein the thickness of said cavity layers are changing in different directions.

14. The composite dispersion compensating structure according to claim 11, further comprising: the means of changing the position of the optical signal input position on the said mirror layer.

15. The composite dispersion compensating structure according to claim 14, wherein the position of the optical signal is changed by adjusting the angle between the dispersion compensating elements.

16. The composite dispersion compensating structure according to claim 1, wherein any of the dispersion compensation units or their combination compensate for third order dispersion.

17. The composite dispersion compensating structure according to claim 1, wherein any of the dispersion compensation units or their combination compensate for second order dispersion.

18. A method for compensating for dispersion in fiber optic communications comprising a step of: opposing dispersion units with cavity layers and mirror layers, wherein the optical signal entering this arrangement reflects many times off both surfaces in an alternating manner, traveling in the space between the two dispersion units between reflections, the amount of dispersion compensation accumulating with each reflection.

19. The dispersion compensation method according to claim 18, wherein each of the dispersion compensation units are at an angle with respect to the opposing dispersion compensation unit, both units compensating for dispersion in an effective manner.

20. The dispersion compensation method according to claim 18, wherein the dispersion compensation units are constructed from thin-film layers.

21. The dispersion compensation method according to claim 18, wherein the thickness of said cavity layer or said cavity layers are changing.

22. The dispersion compensation method according to claim 18, wherein the means of changing the position of the optical signal input position on the said mirror layer, the position of the optical signal is changed by adjusting the angle between the dispersion compensating elements.
